(19) United States
(12) Patent Application Publication
(10) Pub. No.: US 2023/0147838 A1
(43) Pub. Date: May 11, 2023

(54) SYSTEM AND METHOD FOR SELECTING SUPPLIERS, SCHEDULING MEETINGS AND PROVIDING/RECEIVING A SERVICE IN A MEANS OF TRANSPORT OR AT A PREDETERMINED ADDRESS

(71) Applicant: Beyond the Reset, S.A.P.I. de C.V., Mexico City (MX)

(72) Inventor: Agustin VELAZQUEZ GARCIA-LOPEZ, Mexico City (MX)

(73) Assignee: Beyond the Reset, S.A.P.I. de C.V., Mexico City (MX)

(21) Appl. No.: 17/802,704

(22) PCT Filed: Feb. 23, 2021
(86) PCT No.: PCT/IB2021/051518

§ 371 Date: Aug. 26, 2022

(30) Foreign Application Priority Data
Feb. 28, 2020 (MX) MX/A/2020/002353

(51) Int. Cl. G06Q 10/1093; G06Q 50/10

(52) U.S. Cl. CPC G06Q 10/1095; G06Q 50/10

(57) ABSTRACT

A system and method is disclosed for selecting providers, scheduling meetings, and providing/receiving a service in a means of transport or at a predetermined address, enabling a user to remotely access information on a plurality of suppliers, in such a way that one of these may be selected on the basis of the user's needs and the specific capabilities of the supplier, in addition to the possibility of selecting whether the service is received in a means of transport or at the user's own residence. Furthermore, on conclusion of the service requested, the user can obtain documents related to said service, can rate the service and can immediately recommend the same to third parties.

### FIELD OF THE INVENTION

The present invention relates to systems that allow a user to select remotely and using a mobile device (cell phone, tablet, computer or any other communication device known or to be known), a service provider among various service categories and among a plurality of providers, and more particularly is related to a system and method for selecting providers, scheduling meetings, and providing/receiving a service in a transportation mean or at a predetermined address, along with being able to obtain documents related to the service, qualify the service and be able to recommend it to third parties immediately.

### BACKGROUND OF THE INVENTION

In a society as complex as the one we currently live in, it is common that during the course of our daily activities, the need arises to find a service provider, whether at a professional level, at a technical level, of some trade or activities of any kind, such as in the case of a professional level consultant: legal services, medical services, engineering services, architectural services, computer services, telecommunications services, accounting services, real estate services, etc.; at a technical or trade level: design services (clothing, interiors, graphics, etc.), culinary services, plumbing services, electrical services, carpentry services, upholstery services, etc.; tailored to the specific needs of a user.

These needs may vary depending on the person who is looking for the specific service, since the time, cost, availability, quality, prestige, rating or recommendation, and the proximity of the provider, may be a single factor in deciding.

In addition to the fact that to move from one place to another in large cities using a means of transport, in most cases considerable time is required, which is considered as downtime, which cannot be taken advantage of, only reading or reviewing/sending messages on mobile phones, or at other times it is more convenient not to leave home and still be able to answer a consultation or solve a problem that people face daily.

A few years ago, it was very easy to simply seek a recommendation from a friend or family member, in order to have a trusted provider, but as times have changed and the services that may be needed have become more complex, multiple and/or specific, it is more difficult to be able to ask for recommendations or even find someone capable of providing a service with the quality, cost, quality, closeness and availability that we expect.

Likewise, it is an unnecessary waste of resources, having to directly contact each of a set of service providers, to find the one that best suits our specific needs (experience, quality, availability, cost, etc.)

On the other hand, in the ambit of modern society, it is very common for a person to use on online tools (through the Internet), to be able to search for professional service providers; however, the information currently found by online media may be vague and imprecise, since it does not provide the user with real information related to the cost, quality, proximity or availability of the specified service provider.

These online tools can be among others: a) online search, which will show all those companies or professionals dedicated to providing a required service, in this case the client will have to review each site found separately, without being able to see comments from previous users or have access to a fixed rate, much less be able to interview personally the provider, subject to making an appointment, hoping that there is immediate availability; b) use of programming resource software, in which service companies can allow their clients to have online access to appointment scheduling calendars in near real time, but this also means that the user must enter to this resource in each company separately, so the failures in these tools are similar to those of Internet sites.

In the same way, there is currently the “Ask a Lawyer” application, which offers a system where the user, depending on their geographical location, can find assistance from a legal professional, by means of a chat through an application on a mobile device for exchange of questions and answers, so that guidance can be found to solve a legal problem. However, this application does not provide the user with the possibility of having access to more than one proposal simultaneously, having to consult one professional at a time.

Likewise, this application does not provide the technical characteristic of gathering proposals from different providers to give the user the opportunity to choose the option that best suits their needs, in the place where the user is located (by geolocation), receive the service while transported, or receive it in the comfort of the address, after deciding between several options qualified and recommended by the users of the platform.

On the other hand, in the United States Patent Application US2008082980 (Nessland et Al), a system and method for the use of standardized filters and messages to identify and schedule appointments in aggregate resource planning applications is described. However, this application fails to disclose a system and method for filtering providers according to pre-established rankings, as well as fails to disclose a system and method for selecting providers and scheduling meetings where the same provider can be found in different product or service categories.

Likewise, this application also fails to disclose a system where all the databases of information on both users and providers, as well as the information on categories and provider rankings, are located on a remote server. Similarly, this patent application does not include the feature that the user can send their needs to a pool of providers, which will each respond with a proposal according to the user needs and what each provider of this pool is capable of offering.

On the other hand, in the Mexican Patent Application MX/a/2018/005845 of the same inventor of the present invention, a system and method for remote selection of providers and scheduling of meetings is described, which allows a user, remotely access the information of a plurality of providers, so that the user may select one of them based on the needs and the specific capabilities of the provider, in order to schedule a meeting; however, the possibility of providing/receiving a service in a means of transport or at a predetermined address, along with obtaining documents related to the service, qualifying the service and being able to recommend it to third parties immediately, is not offered.

By virtue of the foregoing, it has been sought to eliminate the drawbacks of the prior art, developing a system and method to selecting providers, scheduling meetings, providing/receiving the service in a means of transport, as well as obtain supporting documents related to the service itself, which allows intercommunication between various devices and electronic elements that interact with the system, such as mobile user devices, Internet servers, computers and expert mobile devices, in addition to allowing the service to be offered in a means of transport or in the user own address.

### OBJECT OF THE INVENTION

It is an object of the present invention to provide a system and method for selecting providers, scheduling meetings, and providing/receiving a service in a means of transport or at a predetermined address, which allows a user to access a wide variety of providers and services through a means of transport, or in the own address and obtain the designated services.

It is another object of the present invention to provide a system and method for selecting providers, scheduling meetings, and providing/receiving a service in a means of transport or at a predetermined address, which allows a user to arrange a meeting to receive the service in the means of transport, while traveling to the destination, or at the own address.

It is an additional object of the present invention to provide a system and method for selecting providers, scheduling meetings, and providing/receiving a service in a means of transport or at a predetermined address, which allows a user once the requested service has been completed, may obtain documents related to the service, qualify the service and be able to recommend it to third parties immediately.

### SUMMARY OF THE INVENTION

The system and method for selecting providers, scheduling meetings, and providing/receiving a service in a means of transport or at a predetermined address of the present invention, allows a user to access information from a plurality of providers remotely, so that may select one based on the needs and the specific capabilities of the provider, in addition to being able to select to receive the service in a means of transport or at the user own address.

Likewise, once the requested service has been completed, the user will be able to obtain documents related to the service, qualify the service and be able to recommend it to third parties immediately.

The user of the system uses a mobile device, smart television, computer, or tablet to access a remote application server, where a search for providers is conducted in a provider database, so that the user can select the service provider that best suits the needs. The search can be conducted considering the following: the service category that the user needs, the availability of the provider to serve the user, the quality level of the provider service, the location of the provider and the costs related to the services provided by each specific provider.

The user can perform the search by the category of the required service and the system can give suggestions from different providers with different ranks or levels of service, considering the following: the user history, the user profile, the user location, and provider availability.

Likewise, the user can choose to receive the service in a means of transport, while moving from their original destination to their final destination, or at the own address.

Once the user selects a provider, the user has access to the provider calendar, where the user can make an appointment with the provider at the times available in the calendar, this calendar will be synchronized in real time with the user calendar and with the provider calendar, as well as with the means of transport calendar. Likewise, the system will send a notice or alert to the provider that a user has selected it and has arranged an appointment using a means of transport or requires it at the address that has been indicated.

Upon completion of the requested service, the user will be able to obtain documents related to the service, qualify the service and be able to recommend it to third parties immediately.

### BRIEF DESCRIPTION OF THE FIGURES

The novel aspects that are considered characteristic of the present invention will be established, particularly in the appended claims. However, the invention itself, both for its structure and functionality, together with other objects and advantages thereof, will be better understood from the following detailed description of a preferred embodiment, when read in conjunction with accompanying figures, in which:

FIG. 1 shows a block diagram of the arrangement of the elements that make up a preferred embodiment of a system and method for selecting providers, scheduling meetings, and providing/receiving a service in a means of transport or at a certain address, of the present invention.

FIG. 2 shows a block diagram of an additional embodiment of the method for selecting providers, scheduling meetings, and providing/receiving a service in a means of transport or at a predetermined address.

### DETAILED DESCRIPTION OF THE INVENTION

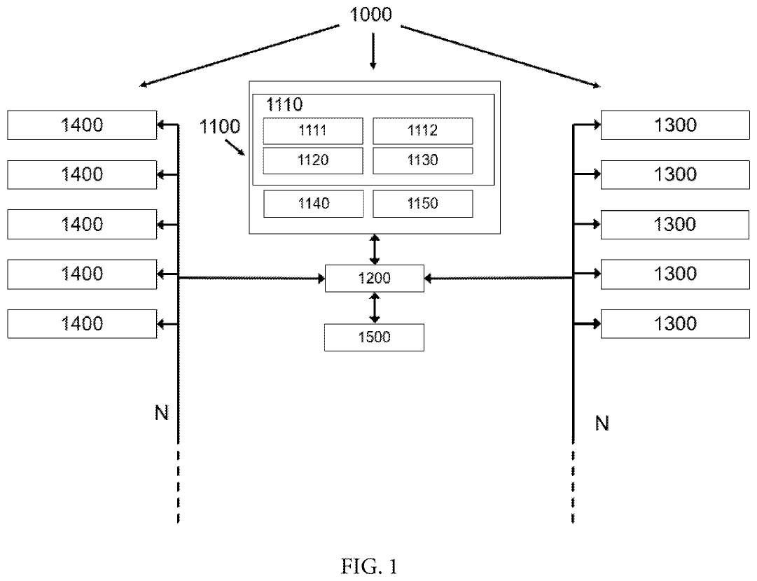

Referring to the drawings and in particular to FIG. 1, it shows a system 1000 for selecting providers, scheduling meetings, and providing/receiving a service in a means of transport or at a predetermined address, of the present invention, which in a preferred embodiment it comprises an application server 1100; at least one consulting provider device 1400; at least one user device 1300; and, at least one means of transport provider device 1500; wherein the application server 1100, at least one consulting provider device 1400, at least one user device 1300 and at least one means of transport provider device 1500, intercommunicate with each other, through a communication network 1200.

The network 1200 can be any computer network that can establish communication between the elements that make up the system of the present invention and shown in FIG. 1.

In a preferred embodiment, the network that is used is the Internet, for which, for purposes of the present invention, it can be understood that most of the communications carried out between the application server 1100 and the devices of the user 1300, the consulting service provider 1400 and the means of transport provider 1500, are performed wirelessly, either by Wi-Fi or some other known technology.

The application server 1100 includes at least one general storage unit 1110 that comprises a user profile memory block 1111, which has the function of storing all the information related to the users that connect to the application server 1100 through their user device 1300; a memory block for consulting provider profiles 1112, which has the function of storing all the information related to the consulting providers that connect to the application server 1100 through their consulting provider device 1400; a consultation storage unit 1120, which has the function of storing all the information related to the consultations made by users; a proposal storage unit 1130, which has the function of storing all the information related to the proposals made by the providers; a means of transport storage unit 1150, which has the function of storing the information of the available means of transport; and, at least one information processing means 1140, which has the function of communicating with the at least one user device 1300, the at least one consulting provider device 1400, and the at least one means of transport provider device 1500 and interact with the other elements contained within the application server 1100.

The information processing means 1140 can also execute computer programs to be able to interact with the user device 1300, the consulting provider device 1400, the means of transport provider device 1500 and the general storage unit 1110.

The general storage unit can be any physical electronic memory capable of storing and using databases of any known and commercially available format.

The at least one user device 1300 and the at least one consulting provider device 1400 can be any computing device that has a screen; a location means such as a GPS; a calendar; a means of inputting information, such as a keyboard or microphone; an information processing medium, such as to execute an application or a computer program to interact with the system and a means to connect to an information network such as the Internet.

The means of transport provider device 1500 can be any computing device that has a screen; a location means such as a GPS; a calendar; a means of inputting information, such as a keyboard or microphone; an information processing means, to execute an application of the means of transport or a computer program to interact with the system and a means to connect to an information network such as the Internet.

The computing device may be included, but not limited to, the group comprising: a personal desktop computer, a tablet, a smartphone, a smart television, or a laptop.

System 1000 is designed to interact with at least one user device 1300, with at least one consulting provider device 1400, and with at least one means of transport provider device 1500, but there can be more than one user device 1300 and more than one provider device 1400 simultaneously interacting with the system.

In the user profile memory block 1111, the user profiles of that operate the user devices 1300 to interact with the application server 1100 are stored, each user profile includes but is not limited to the following information: name, address, age, location, business name, consultation history, user calendar, last connection of user device 1300, links to pending consultations stored in consultation storage unit 1120, user calendar, links to current proposals stored in the proposal storage unit 1130, user reports and ratings, and user banking information.

Every time a user device 1300 accesses the application server, it has the option to edit the information related to its personal data, consult, edit, and synchronize the calendar information of the user device 1300 with the user profile calendar, consult and access information related to the consultation history, consult the status of pending consultations, and consult and access current proposals.

Likewise, the user will be able to make and save new consultations in the consultation storage unit 1120, which will be cataloged as pending consultations and may be accessed by the user through the links in the user profile, likewise, the user will be able to access to proposals related to pending consultations which are stored in the proposal storage unit 1130 and choose the proposals that best solve the problem.

Every time a new user uses a new user device 1300 to access the system for the first time, a new user profile is created, where the data corresponding to the profile must be provided, which will be stored in the user profile memory block 1111 together with the profiles associated with the other user devices 1300, in this case, the consultation history, the pending consultations and the current proposals associated with this user will be empty, as well as the ratings and reviews of the user.

Once the user profile is generated, the user will be able to use the user device 1300 to generate consultations.

Likewise, each time a user device 1300 connects to the system, the real location of the user will be shared with the system to be able to use this information to locate the closest consulting providers, as well as the means of transport provider closest to the user location.

However, it is also possible that the user can request the consultancy of a provider that is not close to the area where user is located, for example, a provider that is in another city that the user will visit in the future, so user can also arrange a meeting.

In provider profile memory block 1112, will be stored all consulting provider profiles that use the consulting provider devices 1400 to interact with application server 1100, each provider profile includes but is not limited to following information: name, age, address, business name, location, service categories in which the provider performs (services offered and cost), provider calendar, provider rank, links to current consultations stored in the consultation storage unit 1120, links to current proposals stored in the proposal storage unit 1130, proposal history, provider ratings and reviews.

Every time a provider device 1300 accesses the application server, the provider will have the option to edit the information related to their personal data, edit, and synchronize the calendar information of the provider device 1400 with the provider profile calendar, consult and access information related to the proposals history, consult the status of current proposals and consult and access new consultations made in the system.

Likewise, the provider may make and save new proposals in the proposal storage unit 1130, in accordance with the current consultations that are stored in the consultation storage unit 1120. Each time a new provider uses a new provider device 1400 to access the system for the first time, a new provider profile is created, where the data corresponding to the provider profile must be provided, which will be stored in the provider profile memory block 1112, along with the profiles associated with the other consulting provider devices 1400, in this case, there will be no links to current consultations or current proposals, and the proposal history and ratings and reviews for this provider will be empty.

Once the provider profile has been generated, the provider will automatically be eligible to receive consultations and generate proposals.

Likewise, each time a consulting provider device 1400 connects to the system, the real location of the provider will be shared with the system to be located, both by the user and by the means of transport provider. In one embodiment of the invention, each consulting provider is in a predetermined level or rank (the provider rank is established by the same provider), since there is a fixed fee associated with each of the ranks of providers and services that offers.

In a preferred embodiment of the invention, there are at least three different ranks of providers, each associated with a different fixed rate.

The service category for a provider can be any consulting service at a professional, technical or trade level.

Consulting at professional level is not limited to one or a combination of the group made up of legal services, medical services, engineering services, architectural services, computer services, telecommunications services, etc.

Consulting at a technical or trade level is not limited to one or a combination of the group made up of design services (clothing, interiors, graphics, etc.), culinary services, plumbing services, electrical services, carpentry services, upholstery services, etc.

On the other hand, the processing means 1140 also comprises notification means, which are responsible for sending a notification to a user device 1300 in the following events: a) a provider has created a new proposal related to one of the consultations of that specific user; b) the consultation created by the user is declared terminated by the system; c) a meeting with a provider is approaching in accordance with the user profile calendar; d) a provider has given a rating and/or a review to the user; and, e) the consultation will be carried out in a means of transport, or else, at the indicated address.

The criteria for the system to declare a consultation finished are the following: a) all the selected providers have made at least one proposal; b) a validity period determined by the user when creating the consultation has elapsed; c) the user has selected a proposal; and d) the user has selected or not, a means of transport.

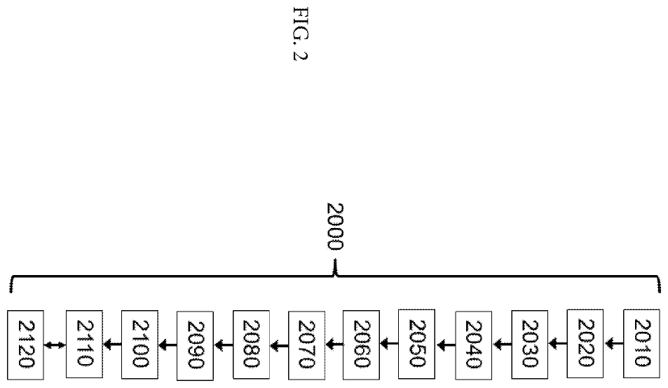

In one of the preferred embodiments of the present invention, a method is described for selecting providers, scheduling meetings, and providing/receiving the service in a means of transport or at a predetermined address 2000, which is illustrated in FIG. 2. The method includes a first step 2010, in which a user uses a user device 1300 to enter (login) to an application server 1100, to use this login, the user must have a username and a password previously established in the system and stored in a portion of the user information memory block 1111 designated for that specific user.

Once the user device is connected to the application server 1100, the user selects in a second step a category 2020 related to the specific service that the user needs, indicating whether the service will be received in a means of transport, or in a selected address; once the category has been selected, a third step 2030 is carried out, in which the user uses the user device 1300 to enter information related to the location and the specific need the user has, this information refers to background of his need and a description of the need, the above so that the providers can have bases to create their proposals, as well as to have user location for the selected means of transport or address 2110.

Once the user has entered the information related to the consultation and user location, in a fourth step 2040, the user can add the consultation expiration time and consultation access privileges, these privileges can give access to the consultation but not limited to the group comprised of: all system providers; only providers that offer services in the same category as the consultation; only providers that meet a certain rating rank or level; only providers that are within a certain radius of proximity to the user; only providers that meet an availability criteria based on the user calendar; only providers selected manually by the user; only providers that can provide the service in a means of transport or at a selected address, or a combination of any of the above.

Once the user has chosen the consultation access privileges and defined the consultation expiration time, in a fifth step 2050, the user can save and submit the consultation and store it in the consultation storage unit 1120, in this time the consultation will be marked as a pending or open consultation, likewise, the at least one data processing means 1140 will send an alert of a new consultation available to each provider device 1300 that has privileges to access that new consultation created by the user.

On the other hand, a provider can use the provider device 1400 to, in a first step 2060, enter (login) an application server 1100. To use this login, the provider must have a provider name and a previously established password in the system and stored in a portion of the provider information memory block 1112 designated for that specific provider.

Once the provider has managed to connect with the application server 1100, in a second step 2070, it can access the consultations generated by user devices 1300, which are available to the provider related to this provider device 1400, based on the consultation access privileges previously established by the users, in this way, a service provider will be able to download on the screen of the provider device 1400, the information related to at least one consultation and based on the needs described in said consultation, in a third step 2080 the provider may prepare at least one proposal.

Proposals must include at least one solution to the consultation made by the client; a provider availability option to schedule a meeting based on the provider calendar availability information stored in the provider profile, once the provider has made their proposal through the provider device 1400, the provider will be able to save and send the proposal, this proposal will be stored in the proposal storage unit 1130 together with the other proposals that other providers have made for this same consultation, thus creating a set of proposals. In this same third step 2080, the data processing means 1140 will send an alert to the user device 1300 associated with a consultation each time a provider device 1300 has created a new proposal related to this specific consultation. There will be no minimum number of proposals that a provider can create for a specific consultation.

According to a fourth step 2090, the user may use the user device 1300 to access this set of proposals stored in the proposal storage unit 1130 to review each of them.

In a fifth step 2100, once the user has chosen a proposal from the set of proposals, the system sends a notification to the provider device 1400 that sent the chosen proposal, and simultaneously the system will synchronize the calendars associated with the user device 1300, the provider device 1400 and the means of transport device 1550, so that the date and time included in the proposal is locked and the meeting between the user and the provider is thus closed.

In one embodiment of the invention, at the time a user chooses a proposal, the amount to be deposited associated with the rank of the chosen provider is set and transferred from the banking account associated with the banking information stored in the user profile, to the banking account of the system administrator, which in turn is associated with the bank information stored in the provider profile who made this proposal, for later transfer.

A sixth step 2110 is performed once the meeting between a user and a provider has concluded, in this step the user uses the user device 1300 to obtain, if desired, documents related to the service, in addition to giving a rating and a review of the provider related to the proposal and the service received, this rating and this review may be seen by users who are interested in using them to provide privileges to this provider or as a selection criterion for a proposal.

Likewise, in this same step, the provider, in addition to providing documents related to the service, if the user requests them, will also give a rating and a review to the user, which will be stored in the user profile and will be seen by the providers at time to make a proposal to the user. Only those users and providers who have scheduled a meeting through the system will be able to give ratings and reviews.

In an additional embodiment, the user of the system and method for selecting providers, scheduling meetings, and providing/receiving a service in a means of transport, can request and receive the service in a means of transport 2120, or else, at a selected address.

The service received in the means of transport or at the selected address can be any type of consultancy, offered by a professional of a certain level of specialization, or a specialist technician or in some trade.

The professional may be a professional with a certain academic degree and certain experience, a specialist technician with a certain experience, or any type of trade.

The modality that described presents an innovative mechanism that, in addition to satisfying the basic transport service (any means of transport known or to be known), provides an additional service consisting of the provision of a consulting service at a professional level, at a technical level, or of some trade.

It is worth mentioning that the operator of the transport service can also be the consulting service provider; in addition to the fact that the consulting service can be offered with the option that at the end of the trip, the operator will give the user the possibility of downloading a document that complements the consultation answered during the trip.

The present modality requires that the at least one user device 1300 and the at least one provider device 1400 can be any computing device that has a screen; a location means such as a GPS; a calendar; a means of inputting information, such as a keyboard or microphone; an information processing medium, such as to execute an application or a computer program to interact with the system and a means to connect to an information network such as the Internet.

The computing device may be included, but not limited to, the group consisting of: a personal desktop computer, a smart television, a tablet, a smartphone, or a laptop.

The operation of the system and method of the present invention begins when the user requests a transport service (any means of transport known or to be known) selecting a place of origin and another of destination.

Having selected the destination, the user will be able to choose the second service offered by the system of the present invention, that is, the user will choose between the various options of professional, technical or trade services that the driver (or whoever handles the transport) could perform, same services that adapt to the needs of the user during the trip.

The user may also decide whether to opt only for the professional, technical or trade service provided via teleconference on their personal desktop computer, smart television, tablet, smartphone, or laptop, through the application and/or portal.

If the user opts for the transport service, as well as the professional service, technical or trade service required, such as in the case of a consultant at professional level: legal services, medical services, engineering services, architecture services, computer services, telecommunications services, accounting services, real estate services, etc.; at the technical or trade level: design services (clothing, interiors, graphics, etc.), culinary services, plumbing services, electrical services, carpentry services, upholstery services, etc.; it would be the provider of the professional service who carries out the transfer work (person who handles the chosen transport).

If private transportation service is selected (any means of transport known or to be known) with a professional driver, technician or provider of some trade, the user will be able to monitor the route traveled by the means of transport, so that when entering the system of the present invention, it will describe in detail the approach of the vehicle towards the starting point, as well as the time of arrival of the user; while the user who has opted only for the videoconference, will be able to define the consultation hours in which one or the other would be available.

If the user chooses the transport service (any means of transport known or to be known) with a professional, technical or trade driver, the user will board the vehicle and during the journey will comment on the concerns to the service provider or trades, or the user may, through the screen of a computer, tablet, smartphone or smart television, clear up the consultation made during the trip, being able to conclude right there, or on the contrary extend over time according to the need of the user.

At the end of the trip or the videoconference, the system will make an automatic charge or cash depending on the option chosen by the user consisting of two items: the transportation service (if applicable) and the provision of professional services or any other nature, whose total price will be made up of a competitive price and less than that set by the market.

Finally, the service provider offers the user, through videoconference or at the end of the transfer, the possibility of downloading on the portal and/or application for free or at an extra cost, which will be automatically charged to the registered payment method, the necessary document or documents that serve as support to the user in the advice with the purpose of solving or supporting the problem, understood by this document among many others, a contract format of any type, a support book, a diet that suits to user needs, a recommendation guide, a list of tasks, among other documents within the wide variety that can be found in the system of the present invention, depending on the type of service that was requested.

Once all the services have been completed, the platform will provide the user with the opportunity to qualify the service(s) offered by the provider based on a five stars parameter, the best rating being when placing the five of them.

In the described embodiment, the service provider in the system and the method for selecting providers, scheduling meetings, and providing/receiving a service in a means of transport or at a predetermined address, offers the service in the means of transport.

The service offered in the means of transport can be any type of consultancy, provided by a professional with a certain level of specialization, or a specialist technician.

The professional may be a professional with a certain academic degree and certain experience, a specialist technician with a certain experience, or in some type of trade.

The present system and method seek to give greater accessibility to professional services providers, technical services, or of any trade, facilitating the offering of these services, by being able to provide clients with a service from the place where they are, as well as offer them the additional service of private transport (any means of transport known or to be known), while the consultation is answered or from a videoconference while they travel to their destination.

Service providers being professionals or people who perform a technique or trade, such as, among others, a lawyer, doctor, psychologist, architect, engineer, nutritionist, designer, plumber, carpenter, electrician, etc. who wish to provide their services with greater ease virtually.

For the operation of the system and method of the present invention, the service provider (professional or person who performs a technique or trade) must download and register in it, being compatible with any computer or device such as a smartphone, smart television, or tablet.

Its use begins when any of the devices indicated above, emits an alert that will notify on the screen a notice to communicate to professionals or people who perform a technique or trade that have been duly registered in the system, that their services have been required by a user that can include the transport service (any means of transport known or to be known) of the user.

Once the providers of services of any kind are notified, they must access the system from the device of their choice to send the user the availability of hours, the rate for the provision of services (professionals, technicians, or trade) of their preference, as well as the service conditions, either operating the chosen means of transport directly, or remotely to provide the service itself.

When said rate is accepted by the user, the service provider in reference will provide from the comfort of his office or the place where is located, either in the vehicle itself, the services required through a videoconference carried out in real time from the system and method of the present invention, or on the other hand, accept the driver service (or the task of handling any transport) that was requested and that must be performed while providing the professional, technical, or trade service consultation required by the user.

The collection of professional, technical, or trade services, will be made to the user together with the collection of the transfer service. In case of having requested only the consultation, said service will be charged to the payment method registered when registering and/or requesting the consultation.

When requesting the private transport service (any means of transport known or to be known), this may be for three different purposes: the first so that the provider of professional, technical or trade services arrives at the meeting point indicated by the user to perform its function at that point, (for example the service offered by a plumber), so the provider will meet a totally independent automated vehicle that will take it to the destination indicated by the user; the second, will consist of the user indicating the meeting point where wishes the provider of professional, technical, or trade services, to pick up the user so that the provider of services and therefore the driver, answer the consultation during the journey to the place where the user will be transferred; and the third, in which the user chooses the transfer by means of an automated and totally independent vehicle, request the provision of professional, technical or trade services to be provided through a videoconference provided in real time during the journey.

In addition to the agreed payment(s), an extra charge will be made if the user decides to access the service provider database to download or, if applicable, buy directly from the system of the present invention, a document supporting the issues consulted, because in the application the user will have access to a wide range of documents, from a contract format of any type, a support book, a diet that suits to user needs, a guide of recommendations, a list of tasks, etc.

In order to improve the system and method of the present invention, once all the services have been completed, the system will provide the service or trade provider with the opportunity to rate the user based on a parameter of five stars, the best rating being when placing the five of them.

Although a preferred embodiment of the present invention has been described, and shown in the foregoing description, it should be emphasized that numerous modifications are possible thereto, without departing from the true scope of the invention.

Therefore, the present invention should not be restricted, except as required by the prior art and the appended claims.

1.-33. (canceled)

34. A system for selecting providers, scheduling meetings, and providing/receiving a service in a means of transport or at a predetermined address, characterized in that it comprises an application server; at least one consulting provider device; at least one user device; and, at least one means of transport provider device; wherein the application server, at least one consulting provider device, at least one user device and at least one means of transport provider device, intercommunicate with each other, through a communication network, which can be any computer network that is capable to establish a communication between the elements that constitute the system, preferably being an Internet network.

35. The system for selecting providers, scheduling meetings, and providing/receiving a service in a means of transport or at a predetermined address, in accordance with claim 34, further characterized in that the Internet network is wireless, of the WI-FI type, or any other technology that allows communication.

36. The system for selecting providers, scheduling meetings, and providing/receiving a service in a means of transport or at a predetermined address, in accordance with claim 34, further characterized in that the application server includes at least one general storage unit comprising a provider profile memory block, which has the function of storing all the information related to the users who connect to the application server through their user device; a memory block for consulting provider profiles, which has the function of storing all the information related to the consulting providers that connect to the application server through their consulting provider device; a consultation storage unit, which has the function of storing all the information related to the consultations made by users; a proposal storage unit, which has the function of storing all the information related to the proposals made by the providers; a means of transport storage unit, which has the function of storing the information of the available means of transport; and, at least one information processing means, which has the function of communicating with the at least one user device, the at least one consulting provider device, and the at least one means of transport provider device and interact with the other elements contained within the application server, the information processing means can also execute computer programs to be able to perform the interaction with the at least one user device, the at least one consulting provider device, the at least one means of transport provider device and the general storage unit, wherein the general storage unit is a physical electronic memory capable of store and use databases of any format known and available on the market; the at least one user device and the at least one consulting provider device can be any computing device that has: a screen, a location means such as a GPS, a calendar, a means to enter information, such as a keyboard or a microphone, an information processing means to run an application or a computer program to interact with the system, and a means to connect to an information network such as the Internet; and, the at least one means of transport provider device can be any computing device that has: a screen, a location means such as a GPS, a calendar, a means to enter information, such as a keyboard or a microphone, an information processing means to execute an application of the means of transport or a computer program to interact with the system and a means to connect to an information network such as the Internet.

37. The system for selecting providers, scheduling meetings, and providing/receiving a service in a means of transport or at a predetermined address, in accordance with claim 36, further characterized in that the computing device may be included, but is not limited, in the group consisting of: a personal desktop computer, a tablet, a smartphone, a smart television, and a laptop.

38. The system for selecting providers, scheduling meetings, and providing/receiving a service in a means of transport or at a predetermined address, in accordance with claim 34, further characterized in that the system can interact with at least one user device, with at least one consulting provider device and with at least one means of transport provider device.

39. The system for selecting providers, scheduling meetings, and providing/receiving a service in a means of transport or at a predetermined address, in accordance with claim 36, further characterized in that the user profile memory block stores the profiles of the users who operate the user devices to interact with the application server, each user profile includes but is not limited to the following information: name, address, age, location, business name, consultation history, user calendar, last connection of the user device, links to pending consultations stored in the consultation storage unit, user calendar, links to current proposals stored in the proposal storage unit, user reviews and ratings, and user banking information; each time a user device accesses the application server, the user has the option to edit the information related to the personal data, consult, edit and synchronize the calendar information of the user device with the user profile calendar, consult and access the information related to the consultation history, consult the status of pending consultations and consult and access the current proposals; in addition to the fact that the user will be able to make and save new consultations in the consultation storage unit, which will be cataloged as pending consultations and may be accessed by the user through the links in the user profile, likewise, the user will be able to access to proposals related to the user pending consultations which are stored in the proposal storage unit and choose the proposals that best solve the problem; each time a new user uses a new user device to access the system for the first time, a new user profile is created, where the data corresponding to the profile must be provided, which will be stored in the user profile memory block together with the profiles associated with the other user devices, where the consultation history, pending consultations and current proposals associated with this new user will be empty, as well as the user ratings and reviews, once the user profile has been generated, the user will be able to use the user device to generate consultations; each time a user device connects to the system, the real location of the user will be shared with the system in order to locate the closest consulting providers and the closest means of transport provider to the user location.

40. The system for selecting providers, scheduling meetings, and providing/receiving a service in a means of transport or at a predetermined address, in accordance with claim 36, further characterized in that the provider profile memory block stores all the profiles of the consulting providers that use the consulting provider devices to interact with the application server, each provider profile includes but is not limited to the following information: name, age, address, business name, location, service categories in which the provider performs (services offered and cost), provider calendar, provider rank, links to current consultations stored in the consultation storage unit, links to current proposals stored in the proposal storage unit, proposal history, provider ratings and reviews; each time a provider device accesses the application server, the provider will have the option to edit the information related to their personal data, edit and synchronize the calendar information of the provider device with the provider profile calendar, consult and access the information related to the proposal history, consult the status of current proposals and consult and access new consultations made in the system; wherein the provider may make and save new proposals in the proposal storage unit, according to the current consultations that are stored in the consultation storage unit; each time a new provider uses a new provider device to access the system for the first time, a new provider profile is created, where the data corresponding to the provider profile must be provided, which will be stored in the provider profile memory block, together with the profiles associated with the other consulting provider devices, once the provider profile is generated, the provider will be automatically eligible to receive consultations and generate proposals; each time a consulting provider device is connected to the system, the real location of the provider will be shared with the system to be able to be located, both by the user and by the means of transport provider, wherein each consulting provider is located at a predetermined level or rank, which is established by the provider itself, where there is a fixed rate associated with each of the ranks of providers and services offered.

41. The system for selecting providers, scheduling meetings, and providing/receiving a service in a means of transport or at a predetermined address, in accordance with claim 40, further characterized in that there are at least three distinct levels or ranks of providers, each associated with a different fixed rate; the service category for a provider can be any consultancy service at a professional, technical or trade level; wherein the professional-level consulting is not limited to one or a combination of the group made up of legal services, medical services, engineering services, architectural services, computer services, telecommunications services or any other branch related to professional services; consultancy at a technical or trade level is not limited to one or a combination of the group made up of design services (clothing, interiors, graphics, among others), culinary services, plumbing services, electrical services, carpentry services, upholstery services or any other branch related to technical or trade services.

42. The system for selecting providers, scheduling meetings, and providing/receiving a service in a means of transport or at a predetermined address, in accordance with claim 36, further characterized in that the processing means also comprises notification means, which they are responsible for sending a notification to a user device in the following events: (a) a provider has created a new proposal related to one of the consultations of that specific user; (b) the consultation created by the user is declared terminated by the system; (c) a meeting with a provider is approaching in accordance with the user profile calendar; (d) a provider has given a rating and/or a review to the user; and, (e) the consultation will be carried out in a means of transport (known or to be known), or else, at the indicated address.

43. A method for selecting providers, scheduling meetings, and providing/receiving a service in a means of transport or at a predetermined address, characterized in that it comprises a first step, in which a user uses a user device to enter an application server by means of an access key (login), to use this login, the user must have a username and a password previously established in the system and stored in a portion of the user information memory block designated for that specific user; once the user device is connected to the application server, the user selects in a second step a category related to the specific service that the user needs, indicating whether the service will be received in a means of transport or at a selected address; once the category has been selected, a third step is carried out in which the user uses the user device to enter information related to their location and the specific need they have, so that providers can have bases to create their proposals, as well as to have their location for the means of transport or the selected address; once the user has entered the information related to the consultation and its location, in a fourth step, the user can add the consultation expiration time and consultation access privileges, these privileges can give access to the consultation such as all system providers, only providers that offer services in the same category as the consultation, only providers that meet a certain rank or level of rating, only providers that are within a certain radius of proximity to the user, only providers that meet availability criteria based on the user calendar, only providers manually selected by the user, only providers that can provide the service in a means of transport (known or to be known) or at a selected address, or a combination of any of the above; once the user has chosen the consultation access privileges and defined the consultation expiration time, in a fifth step, the user will be able to save and send the consultation and store it in the consultation storage unit, marking the consultation as a pending or open consultation, wherein the at least one data processing means will send an alert of a new consultation available to each provider device that has privileges to access that new consultation created by the user.

44. The method for selecting providers, scheduling meetings, and providing/receiving a service in a means of transport or at a predetermined address, in accordance with claim 43, further characterized in that in a first step, a provider uses a provider device to enter an application server through an access key (login), to use this login, the provider must have a provider name and a password previously established in the system and stored in a portion of the provider information memory block designated for that specific provider; once the provider has managed to connect with the application server, in a second step, it can access the consultations generated by the user devices, which are available to the provider related to this provider device, based on the consultation access privileges previously established by the users, in this way, a service provider will be able to download on the screen of the provider device, the information related to at least one consultation and based on the needs described in said consultation; in a third step, the provider will be able to prepare at least one proposal, the proposals must include at least one solution to the consultation made by the client, an provider availability option to schedule a meeting based on the availability information of the calendar provider stored in the provider profile, once the provider has made its proposal through the provider device, the provider will be able to save and send its proposal, which will be stored in the proposal storage unit along with the other proposals that other providers have made for this same consultation, thus creating a set of proposals, in this same step, the data processing means will send an alert to the user device associated with a consultation each time a provider device has created a new proposal related to this specific consultation; in a fourth step, the user will be able to use the user device to access this set of proposals stored in the proposal storage unit in order to review each one of them; In a fifth step, once the user has chosen a proposal and chosen the means of transport or the address where the consultation will take place, the system sends a notification to the provider device that sent the chosen proposal, and simultaneously the system will synchronize the calendars associated with the user device, the provider device and the means of transport device, so that the date, place and time included in the proposal are blocked and the meeting between the user and the provider is thus closed.

45. The method for selecting providers, scheduling meetings, and providing/receiving a service in a means of transport or at a predetermined address, in accordance with claim 44, further characterized in that at the time a user chooses a proposal, it is sets the amount to be deposited associated with the chosen provider rank and is transferred from the banking account associated with the banking information stored in the user profile, to the banking account of the system administrator, which in turn is associated with the banking information stored in the provider profile who made this proposal, for later transfer.

46. The method for selecting providers, scheduling meetings, and providing/receiving a service in a means of transport or at a predetermined address, in accordance with claim 45, further characterized in that in an additional step and once it is carried out and concluded the meeting between a user and a selected provider, the user uses the user device to obtain, if desired, documents related to the service, in addition to giving a rating and a review to the provider related to the proposal and the service received, this rating and this review may be seen by users who are interested in using the provider services; and, the provider, in addition to providing documents related to the service, if the user requests them, will also give a rating and a review to the user, which will be stored in the user profile and will be seen by the providers when making a proposal to the user, wherein only those users and providers who have scheduled a meeting through the system can give ratings and reviews.

47. The method for selecting providers, scheduling meetings, and providing/receiving a service in a means of transport or at a predetermined address, in accordance with claim 46, further characterized in that the user can request and receive the service in a means of transport or at a selected address.

48. The method for selecting providers, scheduling meetings, and providing/receiving a service in a means of transport or at a predetermined address, in accordance with claim 47, further characterized in that the service received in the means of transport or in the selected address can be any type of consultancy, offered by a professional with a different level of specialization, a specialist technician or some type of trade.

49. The method for selecting providers, scheduling meetings, and providing/receiving a service in a means of transport or at a predetermined address, in accordance with claim 48, further characterized in that the professional may be a professional with a certain academic degree and certain experience, such as legal services, medical services, engineering services, architectural services, computer services, telecommunications services, accounting services, real estate services, among others.

50. The method for selecting providers, scheduling meetings, and providing/receiving a service in a means of transport or at a predetermined address, in accordance with claim 48, further characterized in that the technical specialist with a certain experience or some type of trade can be in design services (clothing, interiors, graphics, among others), culinary services, plumbing services, electrical services, carpentry services, upholstery services, among others.

51. The method for selecting providers, scheduling meetings, and providing/receiving a service in a means of transport or at a predetermined address, in accordance with claim 43, further characterized in that the service is offered in a means of transport (any means of transport known or to be known), by the professional or technical specialist or of some type of trade, or at a selected address.

52. The method for selecting providers, scheduling meetings, and providing/receiving a service in a means of transport or at a predetermined address, in accordance with claim 51, further characterized in that the operator of the transport service can also be the consulting service provider; and, at the end of the consultation, the operator will give the user the possibility of downloading a document that complements the consultation answered during the trip.

53. The method for selecting providers, scheduling meetings, and providing/receiving a service in a means of transport or at a predetermined address, in accordance with claim 43, wherein the meeting to receive the consultancy is scheduled in another city that the user will be visited.
